(19) United States
(12) Patent Application Publication
(10) Pub. No.: US 2016/0000524 A1
(43) Pub. Date: Jan. 7, 2016

(54) PROCESS FOR PRODUCING DENTAL RESTORATION

(71) Applicant: 3M INNOVATIVE PROPERTIES COMPANY, Saint Paul, MN (US)

(72) Inventors: REINHOLD HECHT, KAUFERING (DE); UWE H. HOHEISEL, TUERKENFELD (DE); JOHN W. DUBBE, STARNBERG (DE); BERNHARD HOFMANN, PEISSENBERG (DE); THOMAS KLETTKE, DIESSEN (DE); OLIVER KAPPLER, WEILHEIM (DE)

(21) Appl. No.: 14/771,066

(22) PCT Filed: Feb. 27, 2014
(86) PCT No.: PCT/US2014/018960

§ 371 Date: Aug. 27, 2015

(30) Foreign Application Priority Data
Mar. 4, 2013 (EP) 13157530.0

(51) Int. Cl. A61C 5/10; A61C 9/00; A61C 13/15; A61C 13/00

(52) U.S. Cl. CPC A61C 5/10; A61C 13/0003; A61C 9/00; A61C 19/004

(57) ABSTRACT

The invention is related to a process for producing a dental restoration, the process comprising the steps: —shape a dental restoration out of a shapeable material being placed on a dental situation to be restored in the mouth of a patient, —make an impression of the shaped dental restoration placed on the dental situation to be restored by using a dental impression material, —remove the dental impression material and the shaped dental restoration from the dental situation in the mouth of a patient, —place a curable dental composition in the negative mould of the dental impression material relating to the dental situation to be restored. The invention is also directed to a kit of parts comprising a shapeable material, a curable dental composition, optionally a dental cement, optionally a dental impression material, instruction for use.

### FIELD OF THE INVENTION

The invention relates to a process for producing a dental restoration, in particular a long-term or permanent crown and bridge using a dark-curing composition.

### BACKGROUND ART

The production of a dental crown or bridge to restore a destroyed tooth is well known in dentistry. Routinely a dentist is making one or more dental impressions and is forwarding them to a dental laboratory. Based on these dental impressions a dental technician is fabricating a crown or bridge by methods known in the state of the art.

Typically, both the dentist and the patient have to wait for several days or weeks until the final dental restoration can be inserted. During that time a temporary crown or bridge has to be prepared separately and serves as an interim solution. Overall the involvement of an external dental laboratory is a time consuming process.

As an alternative dental crowns can be made by the dentist using CAD/CAM technology in a chair-side procedure. Based on a digital impression a dental crown is milled out of a dental milling block and can be seated at the same day. Compared to the involvement of a dental laboratory this procedure is faster but requires the investment into expensive CAD/CAM technology.

US 2007/0049656 (Jia et al.) describes curable dental restorative compositions useful for the formation of a temporary dental restoration either for chairside or laboratory use. The method of a chairside procedure begins with the step of forming a first dental impression of the teeth to be reconstructed and removing the cured impression material. The teeth are then prepared for a restoration. The practitioner then takes a second impression, this time of the prepared teeth. Construction of the indirect restoration is continued with casting a model of the prepared teeth utilizing the second impression. A couple of further steps are performed before the desired restoration is obtained.

WO 2011/04704 A2 (Corona Dent) relates to long lasting dental restorations and a method for preparation. The method comprises a first stage in which a transient dental restoration is formed by application of first curing process to a dental forming material, followed by a second stage in which the transient restoration is converted into a long-lasting dental restoration by applying further one or more curing processes. Each of said first stage and second stages is independently carried out chair-side by a dentist or in a dental laboratory.

WO 2008/042375 A1 (Densply) describes a method of making a dental restoration on a dental model of a patient's dental anatomy comprising the steps of providing a non-polymerizable shell form having a cavity, introducing a heated second polymerizable material into the cavity of the shell form, placing the shell form over a targeted area on the dental model, allowing the shell and second polymerizable material to cool, irradiating the shell and second polymerizabel material and removing the fully cured restoration from the model.

However, there is still room for improvement especially with regard to the requirements to be fulfilled with respect to modern dental materials. Patients and dentists nowadays have a demand for dental restorations which can be produced in a simple, cost-effective and convenient way, if possible without the need of CAD/CAM technology.

### DESCRIPTION OF THE INVENTION

More particularly, there is a need for a process to produce crowns and/or bridges chair-side without the involvement of a dental laboratory and the investment into expensive CAD/CAM technology

In one embodiment the invention features a process of producing a dental restoration comprising the steps of:
shape a temporary dental restoration out of a shapeable material being placed on a dental situation to be restored in the mouth of a patient,
make an impression of the shaped temporary dental restoration placed on the dental situation to be restored by using a dental impression material,
remove the dental impression material and the shaped temporary dental restoration from the dental situation in the mouth of a patient,
place a curable dental composition in the negative mould of the dental impression material relating to the dental situation to be restored.

The invention is also directed to a kit of parts comprising a shapeable material, a curable dental composition, optionally a dental impression material, optionally a dental cement, and instruction for use containing or describing the process steps as described in the present text.

The invention is also directed to the use of the kit of as described in the present text for producing a dental restoration, in particular a dental crown or bridge

### DEFINITIONS

A “dental composition” or “dental material” or a “composition for dental use” or a “composition to be used in the dental field” is any composition which can be used in the dental field. In this respect the composition should be not detrimental to the patients' health and thus free of hazardous and toxic components being able to migrate out of the composition. Examples of dental compositions include permanent and temporary crown and bridge materials, artificial crowns, anterior or posterior filling materials, adhesives, mill blanks, lab materials and orthodontic devices. Dental compositions are typically hardenable compositions, which can be hardened at ambient conditions, including a temperature range from about 15 to 50° C. or from about 20 to 40° C. within a time frame of about 30 min or 20 min or 10 min. Higher temperatures are not recommended as they might cause pain to the patient and may be detrimental to the patient's health. Dental compositions are typically provided to the practitioner in comparable small volumes, that is volumes in the range from about 0.1 to about 100 ml or from about 0.5 to about 50 ml or from about 1 to about 30 ml. Thus, the storage volume of useful packaging devices is within these ranges.

A “dental situation” means a tooth or teeth structure which should be restored, that is a tooth or teeth being defective, e.g. a tooth or teeth missing tooth structure. The restoration can be done by producing a dental restoration and placing the dental restoration e.g. as a crown or bridge onto the prepared tooth stump.

A “dental restoration” means an indirect restoration, e.g. in form of a crown, bridge, inlay, onlay or veneer.

A “resin system” means one or more resins, each of which can include one or more monomers, oligomers and/or polymers, each comprising polymerizable moieties.

A “monomer” is any chemical substance which can be characterized by a chemical formula, bearing polymerizable groups (including (meth)acrylate groups) which can be polymerized to oligomers or polymers thereby increasing the molecular weight. The molecular weight of monomers can usually simply be calculated based on the chemical formula given.

A “hardenable component, composition or material” or “polymerizable component, composition or material” or “curable component, composition of material” is any component, composition or material which can be cured or solidified e.g. by heating to cause polymerization, chemical crosslinking, radiation-induced polymerization or crosslinking by using a redox initiator. A hardenable component may contain only one, two, three or more polymerizable groups. Typical examples of polymerizable groups include unsaturated carbon groups, such as a vinyl group being present i.a. in a (methyl)acrylate group.

As used herein, “(meth) acryl” is a shorthand term referring to “acryl” and/or “methacryl”. For example, a “(meth) acryloxy” group is a shorthand term referring to either an acryloxy group (i.e., CH₂═CH—C(O)—O—) and/or a methacryloxy group (i. e., CH₂=C(CH₃)—C(O)—O—).

A “filler” contains all fillers being present in the hardenable composition. Only one type of filler or a mixture of different fillers can be used.

A “shapeable material” or “malleable material” or “ductile material” means that the material is capable of being custom shaped and fitted, e.g. to the dental situation in a patient's mouth under a moderate force or stress (e.g. a force ranging from finger pressure to pressure applied with manual operation of a hand tool, such as a dental composite instrument). Shapeable materials can typically be characterized as being ductile, waxy, plastically deformable or kneadable.

Shapeable materials may for example have the rheological properties similar to waxes below the waxes' melting points in that they can be easily deformed and exhibit low elastic recovery. Shapeable materials may also have the properties of thin walled metal, metal foil or alloy. A liquid or powder is not regarded as a shapeable material.

Unless defined otherwise the terms “shaping”, “modelling”, “adapting” or “forming” are used interchangeable. These terms mean that the shape of a subject is willingly changed by a practitioner applying moderate forces.

“Self-supporting” means that the composition is dimensionally stable and will maintain its shape without deformation at room temperature (from about 20° C. to about 25° C.) for at least about 1 week when free standing on a surface (i.e. without the support of packaging or a container).

“Visible light curing” means curing of a resin based composition by applying visible light. The light source used for curing may be LED, halogen, xenon, or laser. The necessary light wavelength for visible light curing materials is typically in a range from about 400 to about 600 nm. Suitable curing times are from about 1 to about 30 seconds or from about 5 to about 20 seconds.

“Dark-curing” or “self-curing” means hardening of a curable resin composition without the need for applying light. Dark-curing or self-curing compositions or materials are typically provided in form of a base and catalyst paste to be mixed before use. Dark-curing or self-curing compositions or materials usually contain components of a redox-initiator system.

The term “visible light” is used to refer to light having a wavelength of about 400 to about 800 nanometers (nm).

“Non tooth colored” means a color which cannot be matched with the color of natural tooth. Tooth colors can typically be characterized by using the Vita™ Shade Guide for tooth colors, which is known to the skilled person. Non tooth colors include every color that differentiates from natural enamel and dentin and includes for example colors like blue, green, red, or colors having a metallic appearance like gold, iron or steel and combinations thereof.

A “dental impression material” is a material used for making impressions of the tooth structure including the gingiva. A dental impression material is usually applied on a dental impression tray. A dental impression material can be based on different chemical substances and crosslink by various chemical reactions (including addition curing and condensation curing materials). Typical examples include silicone based impression materials (e.g. VPS materials) and polyether based impression materials and mixtures of those.

A “(temporary) crown and bridge material” is a hardenable material used for making dental crowns and bridges. These materials are typically used during the time period a dental technician needs for producing a permanent prosthetic work such as a crown or bridge. These time periods can last from a few days (1 to about 6 days), a few weeks (1 to about 4 weeks) or a few months (1 to about 6 month). A long term crown and bridge material is typically used over a time period of at least about 6 to 24 months.

“Ambient conditions” mean the conditions which the inventive composition is usually subjected to during storage and handling. Ambient conditions may, for example, be a pressure of about 900 to about 1100 mbar, a temperature of about −10 to about 60° C. and a relative humidity of about 10 to about 100%. In the laboratory ambient conditions are adjusted to about 23° C. and about 1013 mbar. In the dental and orthodontic field ambient conditions are reasonably understood as a pressure of about 950 to about 1050 mbar, temperature of about 15 to about 40° C. and relative humidity of about 20 to about 80%.

As used herein, “a”, “an”, “the”, “at least one” and “one or more” are used interchangeably. The terms “comprises” or “contains” and variations thereof do not have a limiting meaning where these terms appear in the description and claims. Also herein, the recitations of numerical ranges by endpoints include all numbers subsumed within that range (e.g., 1 to 5 includes 1, 1.5, 2, 2.75, 3, 3.80, 4, 5, etc.).

Unless otherwise indicated, all numbers expressing quantities of ingredients, measurement of physical properties such as described below and so forth used in the specification and claims are to be understood as being modified in all instances by the term “about.”

### BRIEF DESCRIPTION OF FIGURES

FIGS. 1 to 11 show individual process steps for producing a dental restoration according to the invention.

### DETAILED DESCRIPTION OF THE INVENTION

The invention offers a time saving and economic alternative to existing technologies for producing dental restorations, in particular dental crowns and bridges and more particularly long-term or so-called permanent crown and bridges.

In contrast to temporary crown and bridge materials, long-term or permanent crown and bridge materials are designed to stay in the mouth of a patient for at least about 1, 2, 3, 4, 5, 6, 7 or 8 years.

By using shapeable materials for providing a rebuild or restored situation of the dental restoration in combination with a dark-curable composition and using a dental impression technique, a dental restoration with good fit can be produced in a chair-side procedure without using expensive CAD/CAM technology.

The dental restoration described in the present text can be manufactured chair-side, that is, without the need of preparing of a dental model (e.g. made of gypsum) in a dental laboratory. Further, only one step of taking a dental impression using a dental impression material is needed.

The Process for producing a dental restoration described in the present text comprises the steps:
model, shape or adapt a temporary dental restoration out of a shapeable material which is placed on a dental situation to be restored in the mouth of a patient,
make an impression of the modeled or shaped or adapted temporary dental restoration which is placed on the dental situation to be restored by using a dental impression material,
remove the dental impression material and the modeled or shaped or adapted temporary dental restoration from the dental situation in the mouth of a patient,
place a curable dental composition in the negative mould of the dental impression material relating to the dental situation to be restored.

That is, the final dental restoration is produced outside the mouth of the patient by using the negative mould of a cured dental impression material. The mould is obtained by making an impression of the dental situation in the mouth of the patient. Before taking the dental impression, the practitioner has modeled, shaped or adapted a temporary dental restoration by using a preformed and shapeable material. The modeling of the temporary dental restoration can take place outside the mouth of the patient or inside the mouth of the patient or both, inside and outside the mouth of the patient. Before taking the dental impression the temporary dental restoration is located on the dental situation to be restored. Both, the dental impression material and the temporary dental restoration are removed from the mouth of the patient after setting of the dental impression material.

The temporary dental restoration can also be characterized as a rebuild situation. Such a rebuild situation is typically suitable to restore occlusion and proximal contacts.

According to one embodiment, the process for producing a dental restoration described in the present text contains the following process steps:
a) optionally apply a block-out material to the dental situation in the mouth of the patient to prevent undercuts,
b) provide a shapeable material,
c) place the shapeable material onto the dental situation to be restored,
d) adapt the shapeable material to the dental situation to obtain a shaped material or rebuild situation,
e) optionally cure the shaped material to obtain a cured material,
f) take an impression of the shaped material by using a dental impression material,
g) remove the cured dental impression material and shaped material from the dental situation,
h) optionally separate the cured dental impression material from the shaped material,
i) place a dark curable dental composition into the cured dental impression material,
j) place the cured dental impression material filled with the dark curable dental composition onto the dental situation in the mouth of patient,
k) wait until the dark curable dental composition has partially cured to an elastic state,
l) remove the dental impression material and the partially cured dental composition,
m) optionally separate the partially cured dental composition from the dental impression material,
n) cure the partially cured dental composition to a non-elastic state,
o) optionally trim, finish and polish the cured dental composition.

In step (b) a shapeable material is provided.

The shapeable material may be pre-formed or have a pre-formed shape.

Useful pre-formed shapes include dental crown like shapes, that is, shapes which already come close to the shape of the desired dental restoration and only need minor adaptation.

Using a pre-formed material which is also shapeable may further facilitate the modelling of the rebuild situation or dental restoration of the dental situation to be restored.

Ideally, the rebuild situation or shaped material has the shape of the desired final restoration. This will facilitate a good fit of the final restoration.

In certain embodiments the shapeable material fulfils at least one or more, sometimes all of the following features:
self-supporting,
malleable,
curable by visible light,
non-tooth colored.

The shapeable material may be a curable composite material and can be characterized in the cured stage by at least one of, more or all of the following properties:
Elastic dynamic modulus G′: from about 100 to about 50,000 kPa or from about 1,000 to about 5,000 kPa at a frequency of 0.005 Hz,
Viscous modulus G″: from about 50 to about 50,000 kPa or from about 1,000 to about 5,000 kPa at a frequency of 0.0005 Hz,
Flexural strength after hardening: from about 25 to about 200 MPa, or from about 50 to about 150 MPa,
Flexural modulus after hardening: from about 1,000 MPa to about 15,000 MPa.

Using a non-tooth colored shapeable material can be beneficial in that it is better visible and thus may facilitate the shaping and adaptation process especially if this is done in the mouth of a patient.

Suitable colors include for example blue, green, red or colors having a metallic appearance like the appearance of gold, silver, iron or steel.

It can be further beneficial, if the shapeable material has a short curing time or does not need curing at all. This will help to further reduce the time needed to produce a dental restoration according to the process described in the present text.

Examples for a short curing time include:
Exposure to light of a dental curing light: from about 1 to about 120 seconds or from about 5 to about 60 seconds;
Curing time: from about 1 to about 10 minutes or from about 2 to about 5 minutes.

Suitable shapeable materials are also described in WO2003/015720 (3M), WO2005/018483 (3M), WO2006/119003 (3M) or WO2012/057917 (3M). The content of these references is herewith incorporated by reference.

Suitable shapeable materials to be used in this process are for example commercially available in different sizes from 3M ESPE under the brand Protemp™ Crown.

Alternatively also pre-formed and shapeable alloys (commercially available from 3M ESPE under the brand Iso-Form™ crowns or Stainless Steel Crowns) can be used in the process described in the present text.

Pre-formed or pre-contoured shapeable materials are easier to customize using handheld tools.

The shapeable material is placed onto the dental situation to be restored and can be adapted to the dental situation e.g. to rebuild occlusion and proximal contacts.

The adaptation can be done before the shapeable material is placed on the surface of the dental situation, when the shapeable material has been placed on the surface of the dental situation and/or after the shapeable material has been placed and removed from the dental situation.

The adaptation process can be repeated, if desired. After shaping or adapting the material, a shaped or adapted material is obtained.

The shaped material is not intended to be adhesively fixed or cemented to the surface of the dental situation.

In the next step the shapeable material having been shaped or adapted to the desired shape may be optionally cured to obtain a shaped and cured material.

If desired, curing can be done by using a dental curing light. Dental curing lights are known to the practitioners and are commercially available e.g. from 3M ESPE under the brand Elipar™ S10 or Elipar™ Freelight.

In a further step an impression is taken from the rebuild situation in the mouth of the patient. The impression is typically done by using a commercially available dental impression material. The dental impression material is usually filled in a dental tray and the dental tray filled with the dental impression material is pressed on the rebuild situation to obtain a negative image of the rebuild situation. Instead of using a full-arch tray, partial trays can be preferred. The cured dental impression material in combination with the cured and shaped material act as a kind of key or matrix for producing the desired dental restoration. The nature and properties of the dental impression material are not particularly limited unless the desired result cannot be achieved.

Examples of dental impression material include materials based on alginate(s), hydrocolloids, polysulfides, polyether technology, addition curable silicone materials (e.g. VPS materials) and condensation curable silicone materials.

Addition curable silicone materials and curable polyether materials are sometimes preferred due to their better performance and higher accuracy.

The dental impression material is typically characterized by at least one, more or all of the following features:
Consistency (according to ISO 4823): 0,1,2,3;
Setting time: within about 15 min after mixing at ambient conditions (e.g. 23° C.);
Shore A hardness (according to ISO 4823; 24 h): at least about 20 or at least about 40;
Tensile strength (according to DIN 53504): at least about 0.2 MPa or at least about 3.0 MPa;
Elongation at break (according to DIN 53504): at least about 30% or at least about 150% or at least about 200%;
Recovery from deformation (according to ISO 4823): at least about 90% or at least about 95% or at least about 98%.

Suitable dental impression materials are also described in EP 2 072 029 B1, U.S. Pat. No. 6,677,393, EP1 512 724 B1, U.S. Pat. No. 6,127,449, WO 2008/014224 and U.S. Pat. No. 5,569,691. The content of these references is herewith incorporated by reference.

Suitable dental impression materials are commercially available e.g. from 3M ESPE under the brands Impregum™ or Imprint™.

In an additional step the cured dental impression material and shaped material are removed from the mouth of the patient.

If the shaped material is still contained or fixed in the negative mould of the dental impression material, it will be separated from the dental impression material. The resulting dental impression material contains a mould with the negative image of the surface of the rebuild situation of the dental situation of the mouth of the patient.

In a further step, a dark curable dental composition is placed into the mould of the dental impression material, usually only in the mould corresponding to the dental situation to be restored. The nature and properties of the dark-curable dental composition are not particularly limited, either unless the desired result cannot be achieved. The dark-curable dental composition typically is a so-called composite composition and comprises curable component(s), filler(s) and a dark-curing initiator (e.g. redox initiator) as main components. The dark-curable dental composition is typically provided as a kit comprising a base part and a catalyst part. The dark-curable dental composition is typically prepared by mixing the base part and the catalyst part shortly before use.

Mixing can be done by hand or by using a dispenser equipped with a so-called static mixing tip. The dark-curable dental composition can typically be characterized by one, more or all of the following features:
working time: from about 30 sec to about 1.5 min, or from about 45 sec to about 1 min,
setting time: from about 2.5 to about 6 min, or from about 3 to about 5 min,
flexural strength after curing: from about 50 to about 200 MPa (measured according to ISO 4049),
fracture work after curing from about 2.5 to about 15 KJ/m²,
impact strength after curing from about 5 to 15 KJ/m² (measured according to ISO 179-1).

Suitable dark-curable dental compositions are also described in WO 2009/006282 A2, U.S. Pat. No. 7,078,446. The content of these references is herewith incorporated by reference.

Suitable dark-curable crown and bridge materials are commercially available e.g. from 3M ESPE under the brand Protemp™ Temporisation Materials. Other materials which can be used are e.g. Luxatemp™ from DMG, or Integrity™ form Dentsply or Structur™ from VOCO.

The dental impression material filled with the dark-curable dental composition is placed onto the dental situation in the mouth of patient to be restored. The dental impression material and the dark-curable dental composition are left in the mouth of the patient until the dark-curable dental composition has partially cured to an elastic stage.

The time needed to obtain an elastic stage is typically given by the manufacturer of the material in the respective instruction of use. At this stage the dark-curable dental composition is partially cured and is in a rubbery like state. This can be checked by the dentist using e.g. a probe, which is a common procedure in the daily practice.

If desired, the elastic state can be characterized i.a. by its flexural strength or E-modulus which can be determined according to ISO 4049. E.g. a material in an elastic stage may have a flexural strength below about 100 or below about 80 or below about 40 MPa (measured according to ISO 4049). Once the dark-curable dental composition has reached the elastic stage, the dental impression material and the partially cured dental composition are removed from the mouth of the patient.

Removing the partially cured dental composition in an elastic stage is beneficial because this allows an easy removal from the tooth surface without damaging the restoration. If the partially cured dental composition is still contained or fixed in the negative mould of the dental impression material, the partially cured dental composition can be separated from the dental impression material. The partially cured dental composition now has the shape of a crown or bridge fitting to the dental situation to be restored and the final curing or setting reaction of the dark-curable dental composition typically takes place outside the mouth of the patient.

Alternatively, the partially cured dental composition can be left within the dental impression material until the final curing has taken place and can then be separated from the dental impression material. If desired, the cured dental composition can be further adapted or shaped to the desired shape, e.g. by trimming, finishing and/or polishing the composition.

Further, if desired, a relining material (e.g. Filtek™ Supreme Ultra Flowable Restorative from 3M ESPE) can be used to further adapt the shape and fitting of the dental restoration after final cure,

Finally, the dental restoration is placed on the dental situation to be restored in the mouth of the patient and fixed to the respective surface thereof. Fixing is typically done by using a dental cement. The nature and properties of the dental cement are not particularly limited, either unless the desired result cannot be achieved. Especially preferred are adhesive and self-adhesive dental resin cements.

Adhesive or self-adhesive resin dental cement systems typically include a polymerizable monomer, an acidic component optionally comprising a polymerizable moiety, a filler, optionally a basic filler and a redox initiator system.

Suitable cements are also described in WO 2007/140440 A2, US 2010/0016466, US 2004/0110864. The content of these references is herewith incorporated by reference. Adhesive and self-adhesive dental resin cements are commercially available e.g. from 3M ESPE under the brands RelyX™ Unicem, or RelyX™ Ultimate.

The invention is also directed to a kit of part comprising:
a shapeable material as described in the present text,
a dark-curable dental composition as described in the present text,
an instruction for use describing the process steps described in the present text,
optionally a dental cement as described in the present text,
optionally a dental impression material as described in the present text,
optionally a relining material as described in the present text.

Such a kit is in particular useful as it contains all materials and instructions of use needed or helpful for producing dental restorations in a chair-side procedure. The kit as well as the process described in the present text is useful for producing dental restorations, in particular single tooth restorations (including molar and premolar crowns and partial crowns).

According to a one embodiment, the invention is directed to a process as described in the present text, wherein the following materials are used:
the shapeable material being visible-light curing and non-tooth colored,
the dark curable dental composition being selected from dark-curing composite materials such as temporary crown and bridge materials,
the dental impression material being selected from addition curable silicone materials or curable polyether materials,
the dental cement being selected from adhesive and self-adhesive resin cements,
the dental restoration having the shape of a dental crown or bridge.

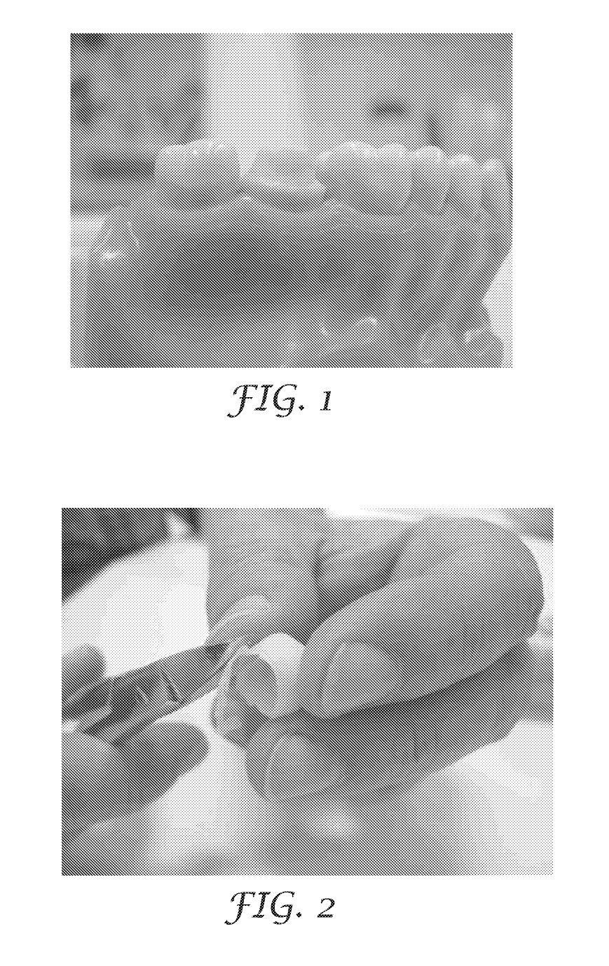

All components used in the dental composition of the invention should be sufficiently biocompatible, that is, the composition should not produce a toxic, injurious, or immunological response in living tissue. The complete disclosures of the patents, patent documents, and publications cited herein are incorporated by reference in their entirety as if each were individually incorporated. The following example is given to illustrate, but not limit, the scope of this invention. The process described in the present text is exemplified by the workflow shown in FIGS. 1 to 11.

FIG. 1 shows the initial situation of the dental situation, a defective tooth which has been prepared and which requires a restoration.

FIG. 2 shows the trimming and adaptation of a pre-formed and shapeable crown to be used for rebuilding the dental situation.

FIG. 3 shows the light curing of the shaped crown having been placed on the dental situation in the mouth of the patient.

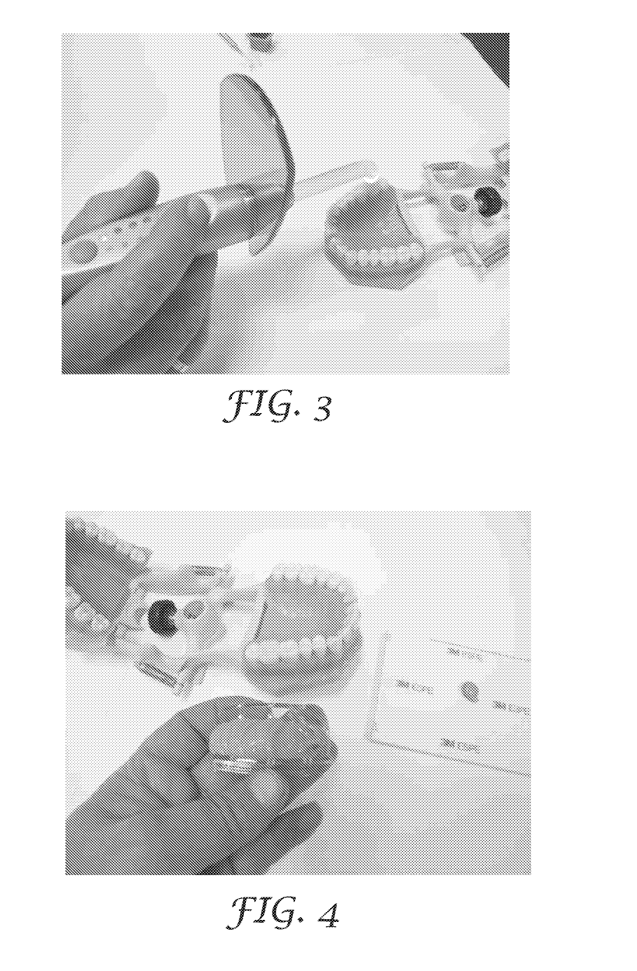

FIG. 4 shows the step of taking an impression of the rebuild situation in the mouth of a patient by using an appropriate impression material.

FIG. 5 shows the set impression material containing the pre-formed crown after removal from the mouth of the patient.

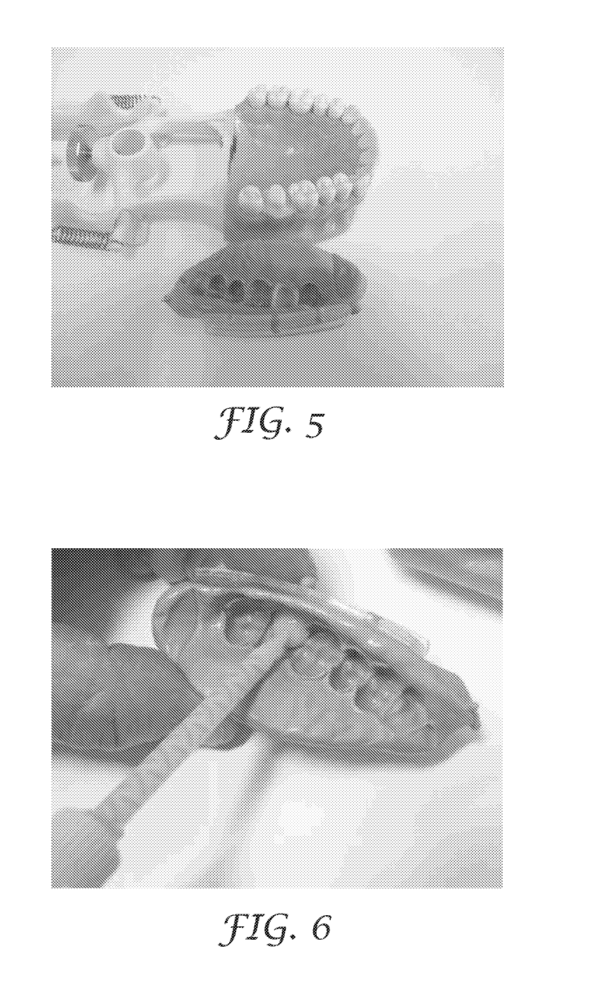

FIG. 6 shows the application of the dark-curable dental composition into the negative mould of the impression material.

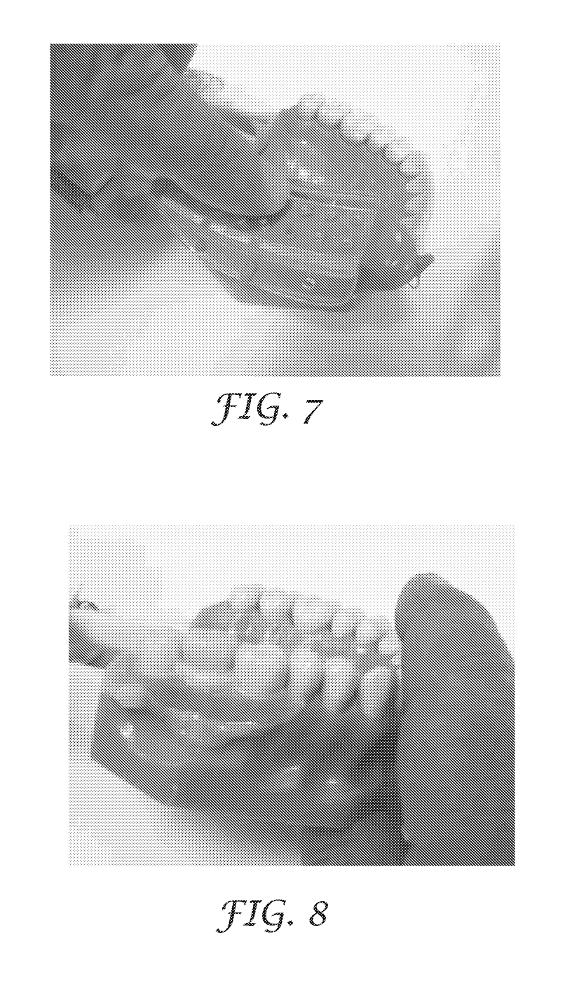

FIG. 7 shows the dental impression material containing the dark-curable dental composition having been re-inserted into the mouth of the patient.

FIG. 8 shows the partially cured dental composition located on the surface of the dental situation to be restored after removal of the dental impression material.

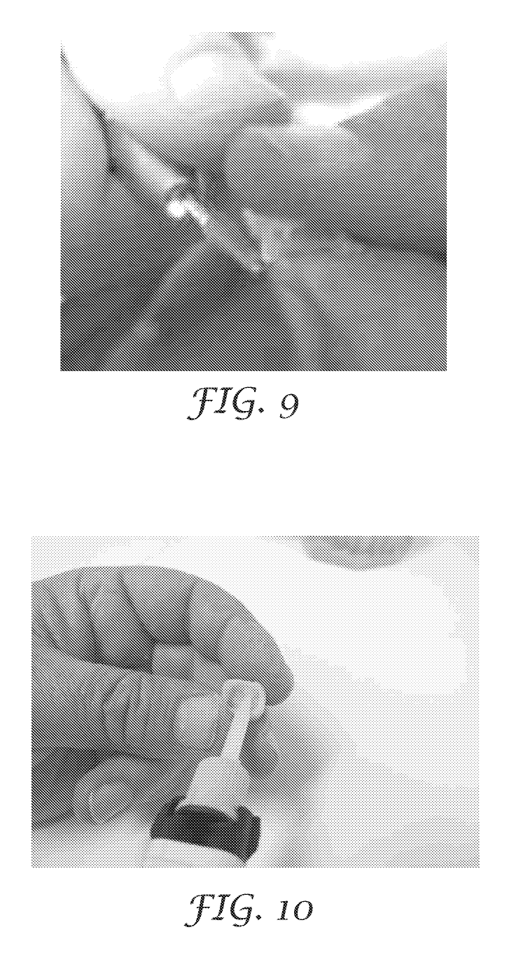

FIG. 9 shows the trimming and finishing of the cured dental composition having now the shape of a crown. If desired, the surface of the obtained crown can be polished.

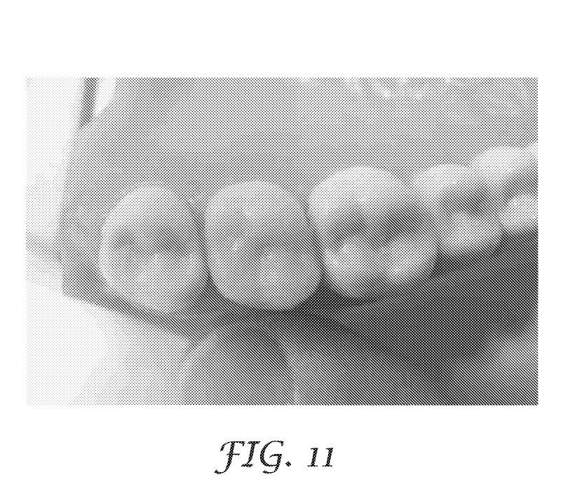

FIG. 10 shows the application of a dental cement on the inner surface of the crown shortly before fixing the crown to the dental situation to be restored.

FIG. 11 shows the restored dental situation in the mouth of the patient.

1-15. (canceled)

16. A process for producing a dental restoration, the process comprising:
shape a temporary dental restoration out of a shapeable material which has been placed on a dental situation to be restored in the mouth of a patient;
make an impression of the shaped temporary dental restoration which has been placed on the dental situation to be restored by using a dental impression material;
remove the dental impression material and the temporary dental restoration from the dental situation in the mouth of a patient; and
place a dark curable dental composition in the negative mould of the dental impression material relating to the dental situation to be restored.

17. The process of claim 16, further comprising:
provide a shapeable material;
place the shapeable material onto a dental situation to be restored;
adapt the shapeable material to the dental situation to obtain a shaped material having the shape of a temporary dental restoration;
optionally cure the shaped material to obtain a cured material;
take an impression of the shaped material by using a dental impression material;
remove the cured dental impression material and shaped material from the dental situation;
optionally separate the cured dental impression material from the shaped material;
place a dark curable dental composition into the cured dental impression material;
place the cured dental impression material filled with the dark curable dental composition onto the dental situation in the mouth of patient;
wait until the dark curable dental composition has partially cured to an elastic stage;
remove the dental impression material and the partially cured dental composition;
optionally separate the partially cured dental composition from the dental impression material;
cure the partially cured dental composition to a non-elastic stage; and
optionally trim, finish and polish the cured dental composition.

18. The process of claim 16, wherein the shapeable material is in a pre-formed state.

19. The process of claim 16, wherein the shapeable material having the shape of a pre-formed crown.

20. The process of claim 16, wherein the shapeable material being characterized by at least one or all of the following features:
being malleable;
being ductile; or
being non-tooth colored.

21. The process of claim 16, wherein the shapeable material comprises a material being selected from curable materials, metals or metal alloys.

22. The process of claim 16, wherein the dental impression material is selected from alginate, hydrocolloid, polysulfide material, polyether material, addition-curable silicone material, condensation-curable silicone material and combinations thereof.

23. The process of claim 16, wherein the dental impression material is characterized by at least one or all of the following features:
consistency according to ISO 4823: 0, 1, 2, 3;
setting time: within about 15 min after mixing at ambient conditions;
shore A hardness according to ISO 4823, measured after 24 h: at least about 20 or at least about 40;
tensile strength according to DIN 53504: at least about 0.2 MPa or at least about 3.0 MPa;
elongation at break according to DIN 53504: at least about 30% or at least about 150% or at least about 200%; or
recovery from deformation according to ISO 4823: at least about 90% or at least about 95% or at least about 98%.

24. The process of claim 16, wherein the dark curable dental composition is prepared by mixing a catalyst paste and base paste.

25. The process of claim 16, wherein the dark curable dental composition comprises:
filler;
curable monomers; and
redox-initiator.

26. The process of claim 16, wherein the dark curable dental composition is characterized by at least one or all of the following features:
working time: from about 30 s to about 1.5 min;
setting time: from about 2.5 to about 6 min;
flexural strength after curing: from about 50 to about 200 MPa measured according to ISO 4049;
fracture work after curing from about 2.5 to about 15 KJ/m²; or
impact strength after curing from about 5 to 15 KJ/m² measured according to ISO 179-1.

27. The process of claim 16, wherein the dental restoration has the shape of a crown or bridge.

28. The process of claim 16, wherein:
the shapeable material is selected from malleable and light-curable composite crowns or stainless steel crowns;
the dark curable dental composition is selected from dark-curing composite materials; and
the dental impression material is selected from addition curable silicone materials or curable polyether materials.

29. The kit of parts comprising:
a shapeable material;
a dark curable dental composition;
instruction for use describing the process of step 16;
optionally a dental cement; and
optionally a dental impression material.

30. The use of the kit of parts of claim 29 for producing a dental restoration, in particular a dental crown or bridge.
